(19) United States
(12) Patent Application Publication
(10) Pub. No.: US 2016/0164986 A1
(43) Pub. Date: Jun. 9, 2016

(54) MULTI-PURPOSE APPLICATION LAUNCHING INTERFACE

(71) Applicant: Google Inc., Mountain View, CA (US)

(72) Inventors: Jennifer Shien-Ming CHEN, San Francisco, CA (US); Alexander Friedrich KUSCHER, San Francisco, CA (US)

(21) Appl. No.: 14/563,655

(22) Filed: Dec. 8, 2014

(51) Int. Cl. H04L 29/08; G06F 3/0488

(52) U.S. Cl. CPC H04L 67/22; G06F 3/0488

(57) ABSTRACT

A computer and a computer-implemented method with a user interface for displaying and queueing notifications in a multi-purpose application environment are provided. The method includes displaying an application launching interface comprising a plurality of applications in response to a user gesture, wherein the application launching interface is hidden from display prior to the user gesture; displaying a notification associated with one of the plurality of applications to the user; and queueing an action when the user provides a queueing gesture for the notification, wherein the queued action is displayed for later performance when selected by the user. A non-transitory computer-readable medium including instructions which, when performed by a processor in a computer cause the computer to perform a method as above is also provided.

### BACKGROUND

1. Field

The present disclosure generally relates to computers, and more particularly to providing a launching interface for applications in a software environment.

2. Description of Related Art

Personal computing devices currently available continue to increase in networking capabilities and processing performance as new capabilities become available. Thus, multiple network-based applications may be installed in a device, and a user may receive notifications from a plurality of them even when the applications appear inactive to the user in the operating system. Furthermore, some applications may be more frequently accessed by the user than others.

In current state-of-the-art user interfaces, a user often needs to browse through a long list of applications installed in memory to select one desired application. Moreover, in some instances the user is required to scan through a large list of applications to find out whether a notification is received in one of them. In some instances, the user needs to launch an application to determine whether a message or a notification has been received.

### SUMMARY

According to one embodiment of the present disclosure, a computer-implemented method is disclosed that provides a user interface for displaying and queueing notifications in a multi-purpose application environment. The method includes displaying an application launching interface comprising a plurality of applications in response to a user gesture, wherein the application launching interface is hidden from display prior to the user gesture; displaying a notification associated with one of the plurality of applications to the user; and queueing an action when the user provides a queueing gesture for the notification, wherein the queued action is displayed for later performance when selected by the user.

According to one embodiment of the present disclosure, a personal computing device is disclosed. The personal computing device has a user interface for displaying and queueing notifications in a multi-purpose application environment. The personal computing device includes a memory storing instructions; a processor configured to execute the instructions; and a display configured to receive a user input. The processor is configured, upon executing the instructions, to cause the personal computing device to display an application launching interface comprising a plurality of application upon receiving a user gesture, wherein the application launching interface is hidden from display prior to the user gesture; to display a notification to a user associated with one of the plurality of applications to the user; to queue an action when the user provides a queueing gesture for the notification, wherein the queued action is displayed for later performance when selected by the user; and to remove the overflow panel from display according to a user priority.

According to one embodiment, a non-transitory computer-readable medium storing machine-readable instructions is provided. The instructions cause a processor to execute a method for providing a user interface for displaying and queueing notifications in a multi-purpose application environment. The method includes displaying an application launching interface comprising a plurality of applications upon a user gesture, wherein the application launching interface is hidden from display prior to the user gesture; displaying a notification associated with one of the plurality of applications to the user; and queueing an action when the user provides a queueing gesture for the notification, wherein the queued action is displayed for later performance when selected by the user. In some embodiments, providing an application launching interface includes spatially separating the plurality of applications according to an application category; and the application category comprises one of a web browsing category, a social networking category, and a media playing category

According to one embodiment, a personal computing device is disclosed that includes a memory storing instructions; a processor configured to execute the instructions; and a means for launching and rapidly accessing applications and notifications in a multi-purpose application environment. The processor is configured, upon executing the instructions, to cause the personal computing device to display an application launching interface including a plurality of application upon receiving a user gesture, wherein the application launching interface is hidden from display prior to the user gesture; to display a notification to a user associated with one of the plurality of applications to the user; to queue an action when the user provides a queueing gesture for the notification, wherein the queued action is displayed for later performance when selected by the user; and to remove the overflow panel from display according to a user priority.

### BRIEF DESCRIPTION OF THE DRAWINGS

FIG. 1 illustrates an example architecture for providing a user interface in a multi-purpose application environment, according to some embodiments.

FIG. 2 illustrates a personal computing device including a display and a user interface, according to some embodiments.

FIG. 3 illustrates a display including a launching interface, according to some embodiments.

FIG. 4 illustrates a display including a launching interface and a plurality of icons associated with people involved in a chat-room application, according to some embodiments.

FIG. 5 illustrates a display including a minimized launching interface, according to some embodiments.

FIG. 6A illustrates a display including a minimized launching interface and a notification from a chat-room application, according to some embodiments.

FIG. 6B illustrates a display including a minimized launching interface and a notification from a media playing application, according to some embodiments.

FIG. 6C illustrates a display including a minimized launching interface and an affordance, according to some embodiments.

FIG. 7 illustrates a flow chart with steps in a method for providing a user interface in a multi-purpose application environment, according to some embodiments.

FIG. 8 is a block diagram illustrating an example computer system with which the personal computing device and server of FIG. 1 can be implemented.

In the figures, elements with the same or similar reference numerals have the same or similar function or steps, unless otherwise indicated.

### DETAILED DESCRIPTION

In the following detailed description, numerous specific details are set forth to provide a full understanding of the present disclosure. It will be apparent, however, to one ordinarily skilled in the art that the embodiments of the present disclosure can be practiced without some of these specific details. In other instances, well-known structures and techniques have not been shown in detail so as not to obscure the disclosure.

The present disclosure relates to methods and systems to displaying a launching interface for rapidly accessing a plurality of applications and notifications in a multi-purpose application environment. Accordingly, the display of the user interface is provided in response to a user gesture, wherein the application launching interface is hidden from display prior to the user gesture. In some embodiments, the plurality of applications accessible on the launching interface is selected by the user according to preference. In some embodiments, at least one of the plurality of applications accessible on the launching interface may be selected by an operating system in a personal computing device of the user according to user historical activity. According to some embodiments the notifications and other affordances associated with each of the applications in the multi-purpose application environment are provided by an Application Programming Interface (API) in an operating system of the personal computing device. Accordingly, the API is configured to communicate with a remote server handling at least one of the applications in the multi-purpose application environment.

Embodiments consistent with the present disclosure allow the user to launch multiple applications from a launching interface upon receipt of a notification from at least one of the applications. Further, embodiments consistent with the present disclosure enable the user to queue an action or an item associated with a notification displayed in the launching interface for later action. Some embodiments include additional affordances to interact with an application in response to a change in state of the application, such as displaying media controls for a media player application in response to a change in media played by the application that the user may handle with simple gestures without the need for a “deep” interaction with the application (e.g., launching a standard interface for the media player application).

In some embodiments, the user may organize frequently accessed applications in a separate launching platform. Moreover, in some embodiments the user may desire to launch one or more of the applications to quickly respond to one of the notifications or modify a control setting in one of the applications. In some instances the user may desire to queue notifications and other items associated with selected applications for later action, rather than interrupt a current activity to focus on the notification. For example, in some embodiments a user may be browsing a webpage and store a number of items from the webpage for later analysis or action, such as a shopping list, rather than focus on a detailed inspection of each item. Further, a user running a media playing application may be multitasking different applications and execute certain basic commands in the media player without the need to open the media playing application.

Embodiments of the present disclosure include touch friendly configurations for use in laptops, smart phones, tablet devices, convertible devices that switch between laptop and tablet configurations, and other mobile devices.

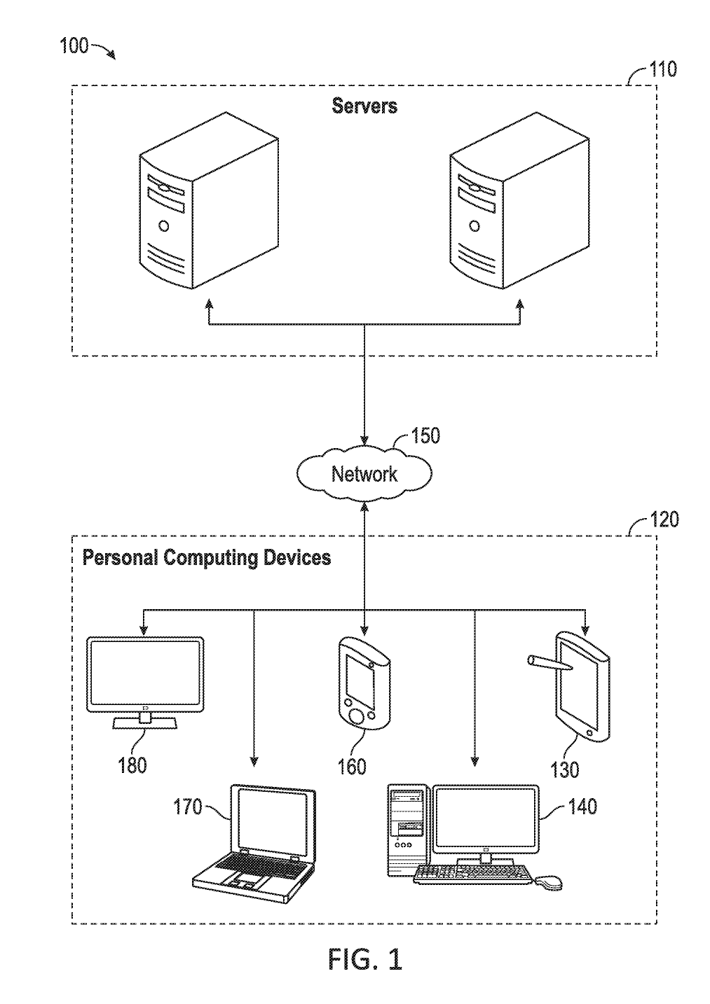

FIG. 1 illustrates an example architecture 100 for providing a launching interface for rapidly accessing a plurality of applications and notifications in a multi-purpose application environment. Architecture 100 includes servers 110 and personal computing devices 120 connected over a network 150. Each of the many personal computing devices 120 is configured to include and execute at least a network based application for displaying content. The network based application can be, for example, a web browser, a document or text editing program, an image editing program, a video editing program, a gaming program, a media player program, a social networking program, or any other program that displays content. The content can be, for example, a web page, a document, an image, a video, an audio file, a game, or other displayable content. Personal computing devices 120 can be, for example, a tablet computer 130 (e.g., including e-book readers), a desktop computer 140, a mobile device 160 (e.g., a smartphone or PDA), a personal computer device 170, a set top box 180 (e.g., for a television), a convertible device (e.g., tablet-to-laptop computer device) or any other devices having appropriate processor, memory, and communications capabilities for displaying content. More particularly, personal computing devices 120 may be associated with registered clients of one or more of servers 110.

In certain aspects, the content for display in the application can be obtained from one or many servers 110 over network 150. Servers 110 can be any device having an appropriate processor, memory, and communications capability for hosting the content for display. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

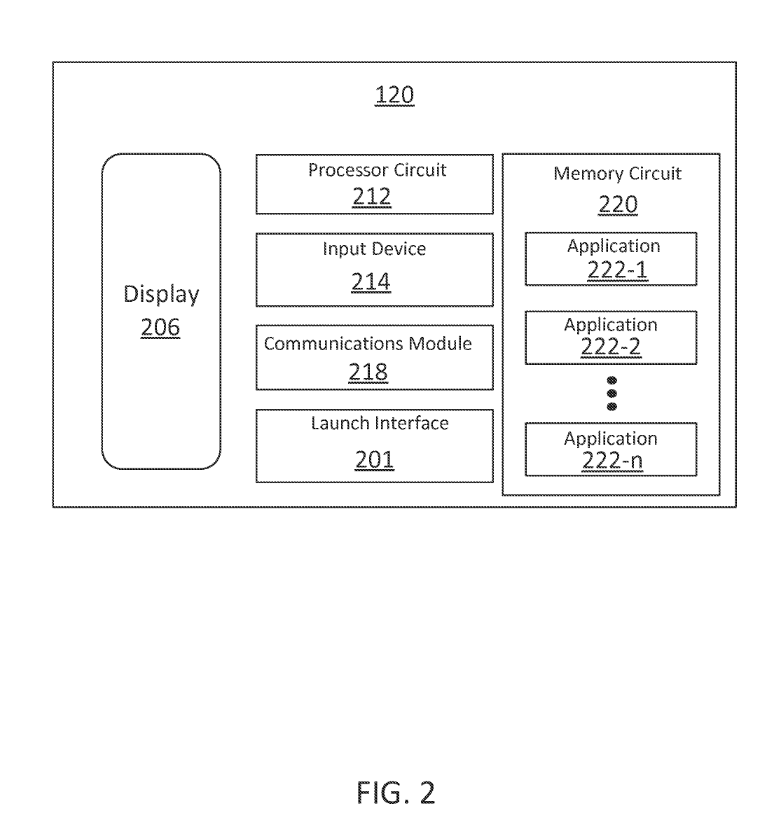

FIG. 2 illustrates a personal computing device 120 including a launching interface 201, according to some embodiments. Personal computing device 120 includes a display 206. In some embodiments, display 206 is a touch sensitive display. Accordingly, launching interface 201 is configured to provide a platform for rapidly accessing a plurality of applications and notifications in a multi-purpose application environment to display 206. Personal computing device 120 also includes a processor circuit 212, an input device 214, a communications module 218, and a memory circuit 220.

Processor circuit 212 is configured to execute commands stored in memory circuit 220 so that personal computing device 120 performs steps in methods consistent with the present disclosure. In some embodiments, memory circuit 220 includes an operating system configured to load commands from launching interface 201 into processor circuit 212. Input device 214 is, for example, a keyboard, or touch sensitive interface. In some embodiments input device 214 includes a mouse or a pointer device (including the user's finger). Accordingly, input device 214 is configured to operate in parallel with a touch screen in display 206. Communications module 218 is configured to couple device 120 with network 150 and access network server 110. Accordingly, communications module 218 can include wireless circuits and devices, such as Radio-Frequency (RF) antennas, transmitters, receivers, and transceivers. In some embodiments, communications module 218 includes an optical fiber cable, or a wire cable, configured to transmit and receive signals to and from network 150. Memory circuit 220 may include a first application 222-1, a second application 222-2, and any number of applications up to 222-n (hereinafter collectively referred to as ‘applications 222’) where ‘n’ is any integer. Applications 222 include data and commands which, when executed by processor circuit 212, cause device 120 to perform operations including transmitting and receiving data and commands to and from a server 110 through network 150. In that regard, each of applications 222 include a window in display 206. Launching interface 201 includes icons for each of at least one or more applications 222 in display 206. In some embodiments, the plurality of applications 222 included in launching interface 201 is adjustable according to user preferences.

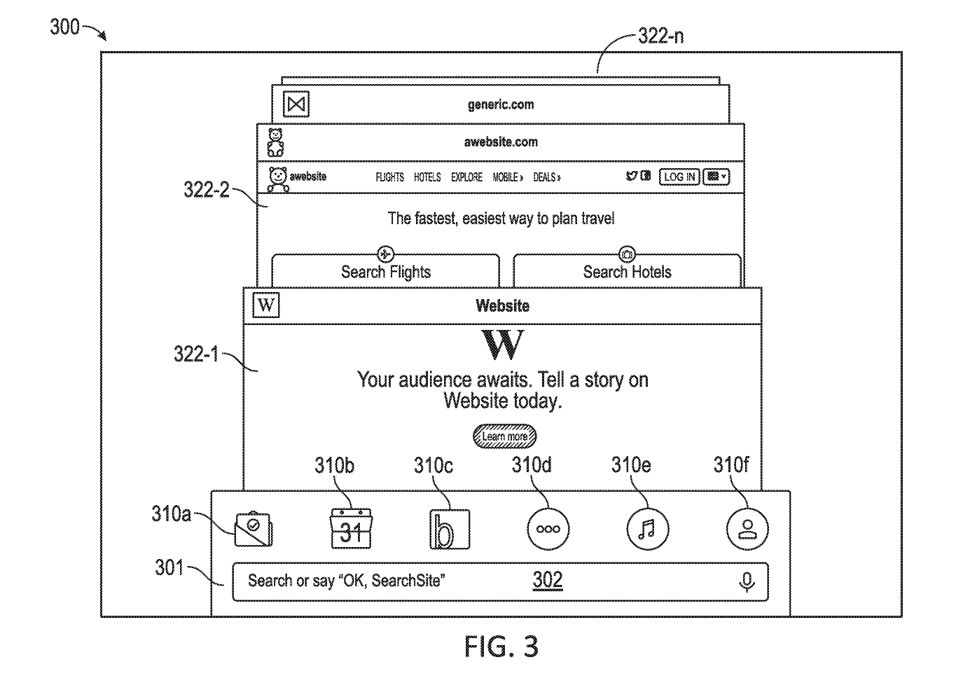

FIG. 3 illustrates a display 300 including a launching pad 301, according to some embodiments. Launching pad 301 is a launching interface that enables the user a quick access to a plurality of applications for launching or refocusing (e.g., launching interface 201). According to some embodiments, launching pad 301 is an overflow panel or tray that appears in the user display as a light bar. Launching pad 301 may appear in response to a notification, or may appear in response to a user request to display the launching pad. Launching pad 301 includes a search tab 302, and a plurality of most likely used applications arranged into buckets 310a, 310b, 310c, 310d, 310e, and 310f (hereinafter collectively referred to as ‘buckets 310’). Buckets 310 provide a spatial categorization within launching pad 301 for applications installed in the personal computing device. Some of the applications in buckets 310 may include at least one of applications 322. More generally, applications in launching pad 301 may be selected by the user, or placed in launching pad 301 by the operating system according to a user access frequency.

Buckets 310 simplify the organization and display of launching pad 301. The buckets can prioritize people contacts, media players, and other applications that the user may access repeatedly. Accordingly, bucket 310a may include applications related with travel and transportation. Bucket 310b may include applications regarding calendars, appointments, and dates. Bucket 310c may include applications associated with social networking Bucket 310d may be associated with applications having a miscellaneous type. Bucket 310e may be a media bucket associated with a media player, and bucket 310f may be a chat bucket including ‘avatars’ or icons representing people from a user's contact list. In some embodiments, buckets 310 may include a ‘catch-all’ bucket including miscellaneous applications that may not fit in any of the categories established for other buckets (e.g., buckets 310a-f). Display 300 also includes applications 322-1, 322-2 up to 322-n (collectively referred hereinafter as applications 322), which the user may be running, or have installed in memory circuit 220. In that regard, launching pad 301 provides the user with a quick access to applications of particular interest. Furthermore, the user may quickly access any other application from launching pad 301 by use of search tab 302.

Launching pad 301 enables launching a new application, and also refocusing or bringing a running application back into view, for the user to take an action. Accordingly, launching pad 301 can provide a combination of launching and refocusing actions to the user. For example, in some embodiments the user can open a new application 322 or website from launching pad 301. Likewise, in some embodiments the user can bring an application 322, or items associated with the application, back into view of the user for refocusing on the items. Launching pad 301 appears on display 206 upon request by a user gesture, and may be minimized by another user gesture, such as double tapping. The launching pad's appearance and disappearance thus produces minimal intrusion into the user's current activity, and reduces the number of gestures (e.g., clicks) that a user makes to launch, quit, or queue a desired application by responding to a corresponding notification.

The user may establish preferences for the appearance and interface features of launching pad 301 and notifications stemming from it. Accordingly, the user may add applications 322 to a bucket or remove applications 322 from a bucket, as desired. In one instance, the user may store a list of media files to be played in a certain order in a media player bucket 310e. In other embodiments, the user may store a list of people from a contacts list, in order of relevance to their messages and communications, or in order of time elapsed since last communication, in chat bucket 310f.

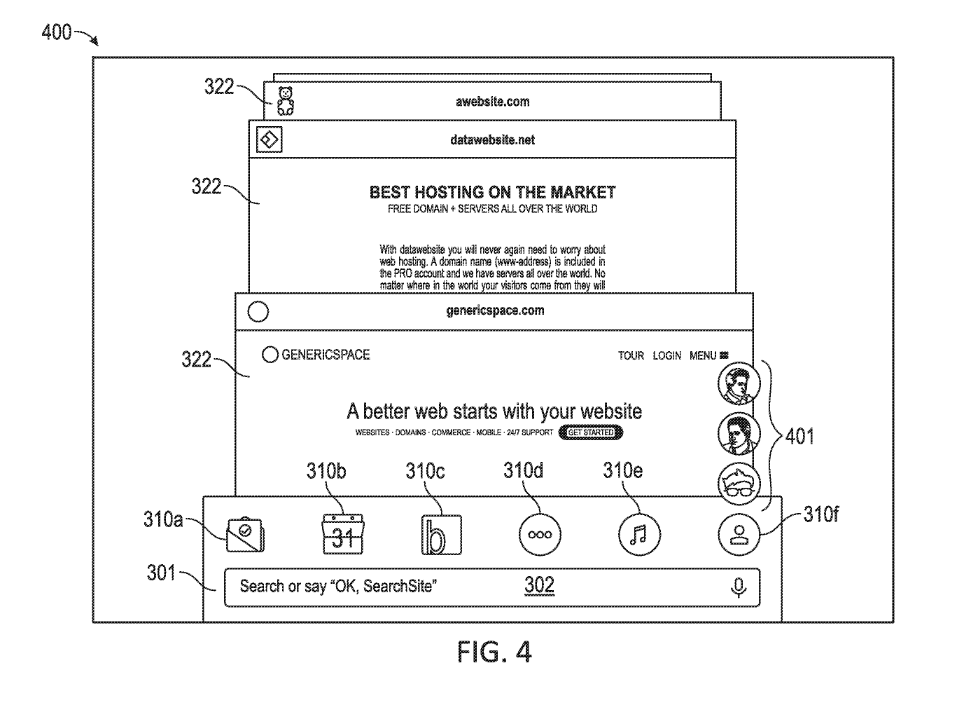

FIG. 4 illustrates a display 400 including launching pad 301, according to some embodiments. In some embodiments launching pad 301 includes a display of each of the icons associated with an application in a bucket 310. For example, in the case of chat bucket 310f, launching pad 301 may display different icons 401 representing people involved in a chat room with the user, people frequently accessed by the user, people who have recently provided chat requests to the user, or people in a user's contact list. Some embodiments display individual icons 401 upon the user hovering with a finger or pointer over the icon for chat bucket 310f Likewise, in the case of media bucket 310e, display 400 may display icons associated with albums or files accessed by the media player when a user hovers over the icon for bucket 310f In some embodiments, icons shown by display 400 include all of the icons contained within a specific bucket 310. In some embodiments, display 400 only shows the most recently accessed icons, such as the last three or four icons accessed by the user from within a given bucket.

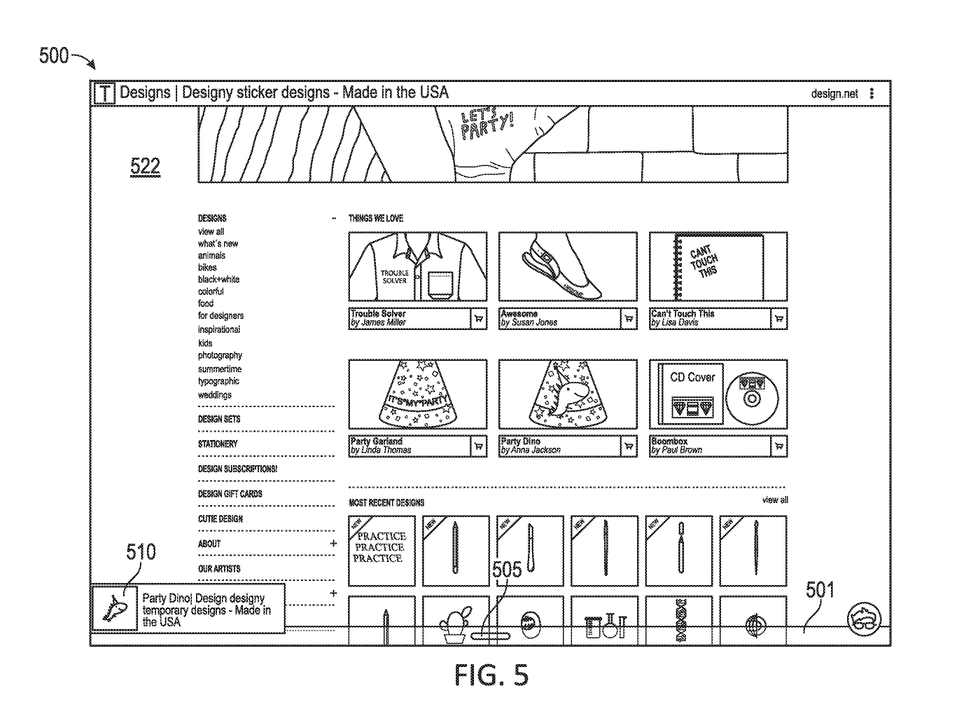

FIG. 5 illustrates a display 500 including a minimized launching pad 501, according to some embodiments. Display 500 illustrates an icon 510 appearing on display 500 out of minimized launching pad 501. Accordingly, the user may drag items from a currently running application 522 into icon 510, so that the items may be accessed at a later time from minimized launching pad 501 without the need to re-launch application 522, search for the item, and access it. In that regard, display 500 allows the user to refocus attention to items stored under icon 510 at a later time. Without limitation, currently running application 522 may be a web browser displaying the website of a retail store, and the items may be shopping items from the retail store. Accordingly, the user may operate minimized launching pad 501 as a shopping cart for items found in a website. The shopping cart would be accessible to the user even when application 522 is not active. Indeed, the user may access the list of items associated with icon 510 simply by activating tab 505, which overflows launching pad 501 onto display 500 displaying its contents to the user. In some embodiments, the shopping list stored in icon 510 is an ordered list of items. In some embodiments, the list is ordered according to price, to a user preference, or time at which the item was dragged into icon 510. In some embodiments, running application 522 may be a chat room in a social networking environment, and the items may be chat requests, notifications, or messages transmitted by chat-room partners (e.g., selected from icons 401).

Accordingly, items stored in minimized launching pad 501 include web accessible items from a web browsing application. For example, minimized launching pad 501 may include items associated with a universal resource locator (URL) address, people in a contacts list of a social networking application, or a list of media items to be played by a media playing application. Other applications in the launching pad may include: document processing applications and database handling applications, mathematical computing applications, and other applications involving collaborative work on a document publicly available through a remote server (e.g., at least one of servers 110). For example, the current owner of the document may receive a notification in minimized launching pad 501 that a different user requests access and privileges to the document.

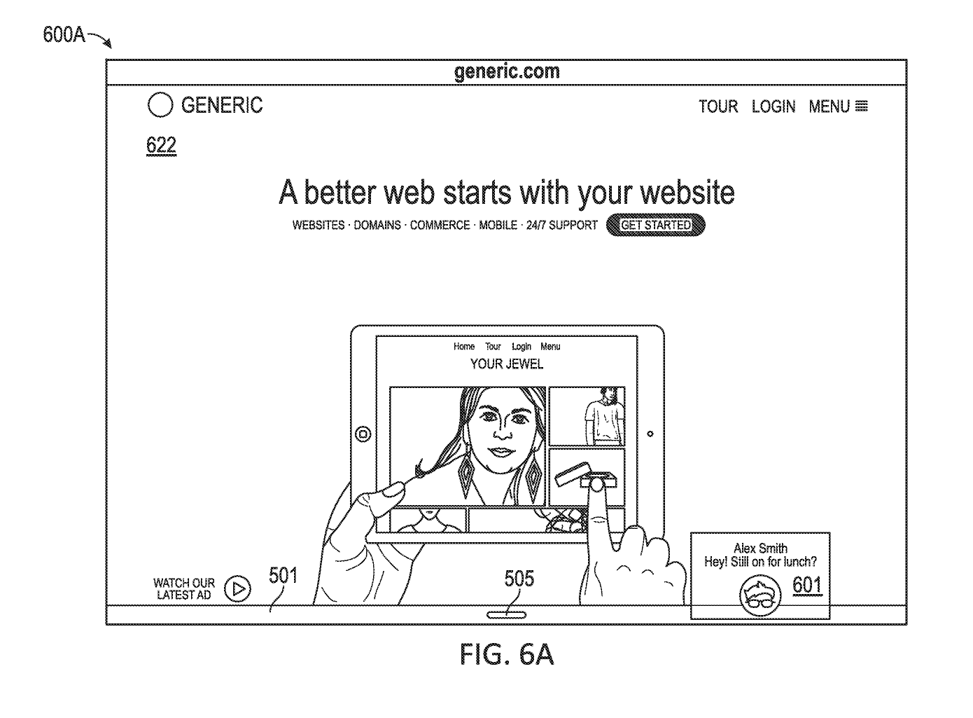

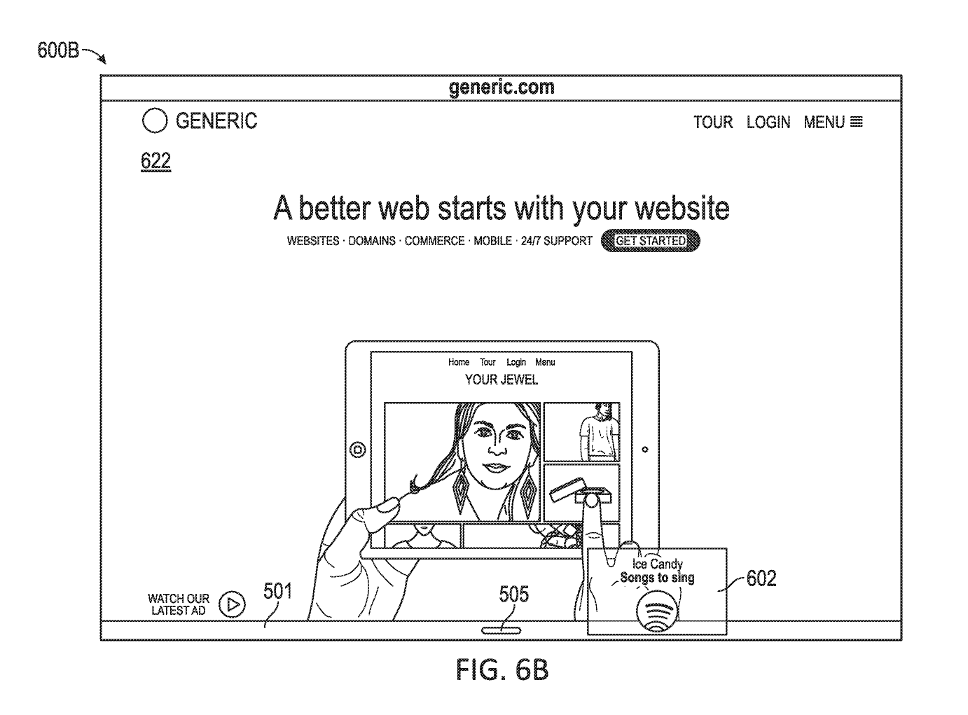

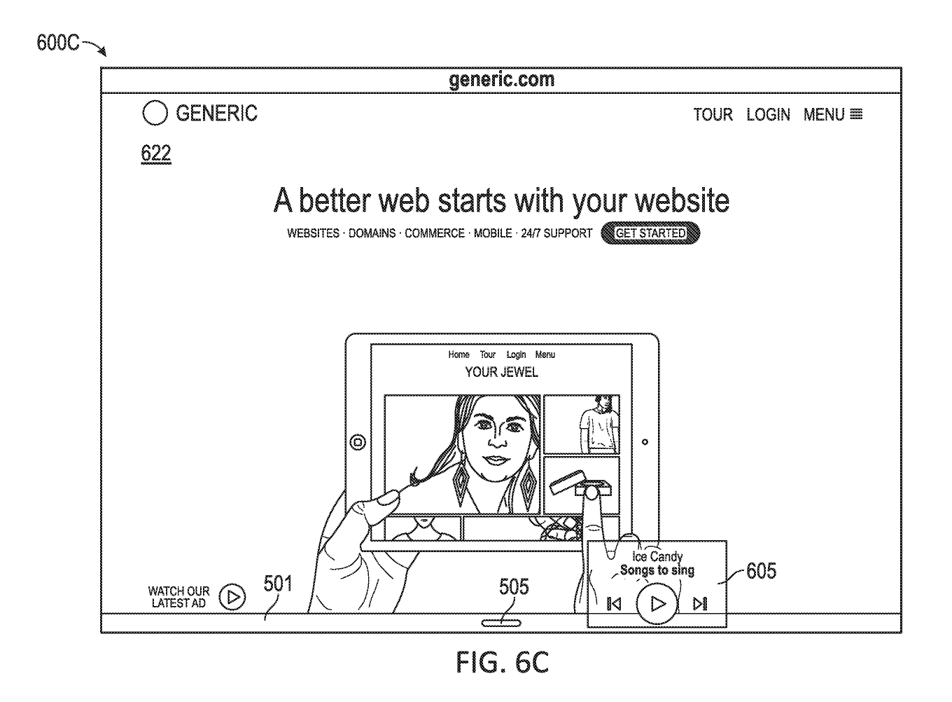

FIG. 6A illustrates a display 600A including a minimized launching pad 501 and a notification 601, according to some embodiments. An application 622 may be running when notification 601 appears from launching pad 501. Minimized launching pad 501 may be minimized so that the user focuses on application 622. Notification 601 may be associated with a social networking or chat-room application placed in minimized launching pad 501 (cf. bucket 310f). For example, notification 601 may be a text message or a chat request from a person in the chat-room trying to reach the user. The user may decide to respond to the notification immediately, or to queue the request to be addressed at a later time with a queueing gesture. In some embodiments, the queueing gesture includes a single tap on notification 601, or a swipe in a direction approximately towards minimized launching pad 501. Notification 601 is removed from screen in display 600, for example, when the notification is addressed by the user or ignored for a predetermined period of time, or in response to a user request to display or hide launching pad 501.

In some embodiments, notification 601 may overflow minimized launching pad 501 momentarily, to attract the user's attention. For example, notification 601 may move vertically above a position within or immediately adjacent to launching pad 501, return to minimized launching pad 501, and disappear from the user's view. In some embodiments, notification 510 may be filtered out of minimized launching pad 501 according to relevance to the user. The relevance to the user may be explicitly provided by the user, or may be determined by analyzing user activity history. In some embodiments, notification 510 returns to minimized launching pad 501 when the user gently taps on the icons associated with the different notifications. Icons may be selected according to the bucket to which the icon belongs. For example, for items associated with a web browser application, a representative figure for a specific webpage may be used for the icon associated with notification 601 for the web browser application. In a social network application, a person's avatar may be the icon used for a notification 601 related to the person. Accordingly, in some embodiments notifications from an installed application can be configured to appear in minimized launching pad 501 through appropriate configuration of the installed application using an Application Program Interface (API) for the launching pad, provided by the operating system.

FIG. 6B illustrates a display 600B including minimized launching pad 501 and a notification 602, according to some embodiments. As in FIG. 6A, minimized launching pad 501 is minimized while application 622 is running In the configuration illustrated in FIG. 6B, notification 602 appears from minimized launching pad 501. Notification 602 may be associated with a media playing application placed in minimized launching pad 501 (cf. bucket 310e). For example, notification 602 may indicate that a new album is on queue for playing by the media playing application. Accordingly, notification 602 may indicate the name of the album, title, and other relevant information for view by the user. As in the case of notification 601, the user may decide to open the album, or simply ignore the notification. In some embodiments, the user can configure launching pad 501 to determine from which applications 322 the user would like to receive notifications 601 and 602.

FIG. 6C illustrates a display 600C including minimized launching pad 501, and an affordance 605, according to some embodiments. Affordance 605 may include a control panel allowing the user a direct access to an album in a media player application (included in media bucket 310e) without stopping or pausing running application 622. While the features in affordance 605 are limited when compared to the controls accessible through the active media playing application, media controls in affordance 605 allow the user to have quick access to play or skip tracks on an album, while focusing attention to currently active application 622.

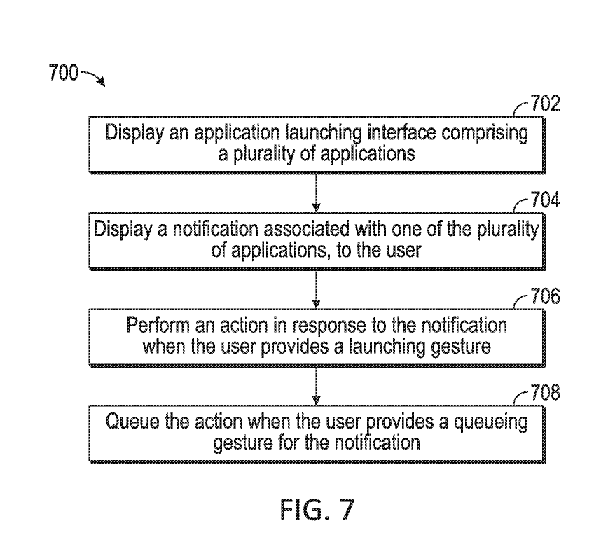

FIG. 7 illustrates a flow chart in a method 700 for providing a user interface for displaying and queueing notifications in a multi-purpose application environment, according to some embodiments. Steps in method 700 can be performed by a processor circuit in a computer, the processor circuit executing commands stored in a memory circuit of the computer. The computer in method 700 is a personal computing device as described above (e.g., personal computer device 120). Accordingly, steps in method 700 can be partially or completely performed by processor circuit 212 in personal computing device 120, executing commands stored in memory circuit 220. In some embodiments, the commands include software in a user interface (e.g., launching interface 201) configured to control a touch sensitive display (e.g., display 206). The user interface in method 700 displays a plurality of windows on display 206, where each window is associated with an application installed in the memory circuit of the personal computing device (e.g., applications 222). The display may further include a launching pad where a plurality of applications installed in the personal computing device may be arranged in buckets (e.g., launching pad 301 and buckets 310). Embodiments consistent with method 700 include at least one of the steps illustrated in FIG. 7, performed in any order. Furthermore, in some embodiments consistent with method 700, steps illustrated in FIG. 7 are performed simultaneously in time, or approximately simultaneously in time. Accordingly, in some embodiments consistent with method 700, steps in FIG. 7 are performed at least partially overlapping in time. Moreover, in some embodiments consistent with method 700, other steps can be included in addition to at least one of the steps illustrated in FIG. 7.

Step 702 includes displaying an application launching interface including a plurality of applications. In some embodiments, the application launching interface includes an overflow panel displayed in response to a notification to the user, or in response to a request from the user. In some embodiments, step 702 includes spatially separating different applications from the plurality of applications according to a plurality of buckets, each bucket associated with an application category. In some embodiments, step 702 includes displaying the application launching interface in response to a user gesture. Accordingly, the user gesture may be any one of a tap, a click, or a swipe from the user on a minimized launching pad (e.g., minimized launching pad 501). For example, in some embodiments the user gesture may be a tap or a swipe starting from an activating tab provided on the minimized launching pad (e.g., activating tab 505). Further according to some embodiments, the application launching interface may be hidden from display prior to the user gesture. In some embodiments, step 702 may include displaying the application launching interface in response to a user activity including, for example, shaking the device or moving the device in a pre-determined direction.

Step 704 includes displaying a notification associated with one of the plurality of applications, to the user. In some embodiments, the plurality of applications includes a social networking application; and step 704 includes displaying a chat request from a person associated with the user in the social networking application. In some embodiments, the plurality of applications comprises a media playing application, and step 704 includes displaying a media player control, where the launching gesture includes selecting one of a play button, a pause button, a skip button, a mute button, or an unmute button. More generally, step 704 may include displaying an affordance to provide the user easy access to a limited range of actions on one of the plurality of applications, while the user is focused on a different application.

Step 706 comprises performing an action in response to the notification when the user provides a launching gesture. In some embodiments, step 706 includes a launching gesture by double tapping on an icon representing the application. In some embodiments, step 706 includes removing the notification from display according to a user gesture or after a selected period of time.

Step 708 includes queueing the action when the user provides a queuing gesture for the notification. In some embodiments, the queueing gesture in step 708 includes a swiping gesture. In embodiments where the application in the application launching interface is a web browsing application the queueing gesture may include a gesture indicating a request to store a Uniform Resource Locator (URL) item in a web browser bucket. For example, in some embodiments a user browsing a website for online retail sales may generate a ‘shopping cart’ in the application launching interface. The shopping cart may include items selected for later purchase. Accordingly, the user may simply access the shopping cart in the launching pad to examine the items at a later time, eliminate some items from the shopping list, or purchase some of the items. A similar queueing procedure may be performed in step 708 when the user selects chat requests or reminders from an application in a chat bucket (e.g., bucket 310f) to be stored in the launching interface for further action. For example, in some embodiments a friend may send reminders for an upcoming meeting that the user may desire to queue for later revision. Further according to some embodiments, the user may queue notifications from an airline service application regarding a flight status of an upcoming trip. In yet other embodiments, the user may queue maps, traffic, and transportation details from a map and transit application for later access at a commute time, or at a scheduled event. Moreover, in some embodiments step 708 may include a combination of any one or more of the above queuing actions in the application launching interface.

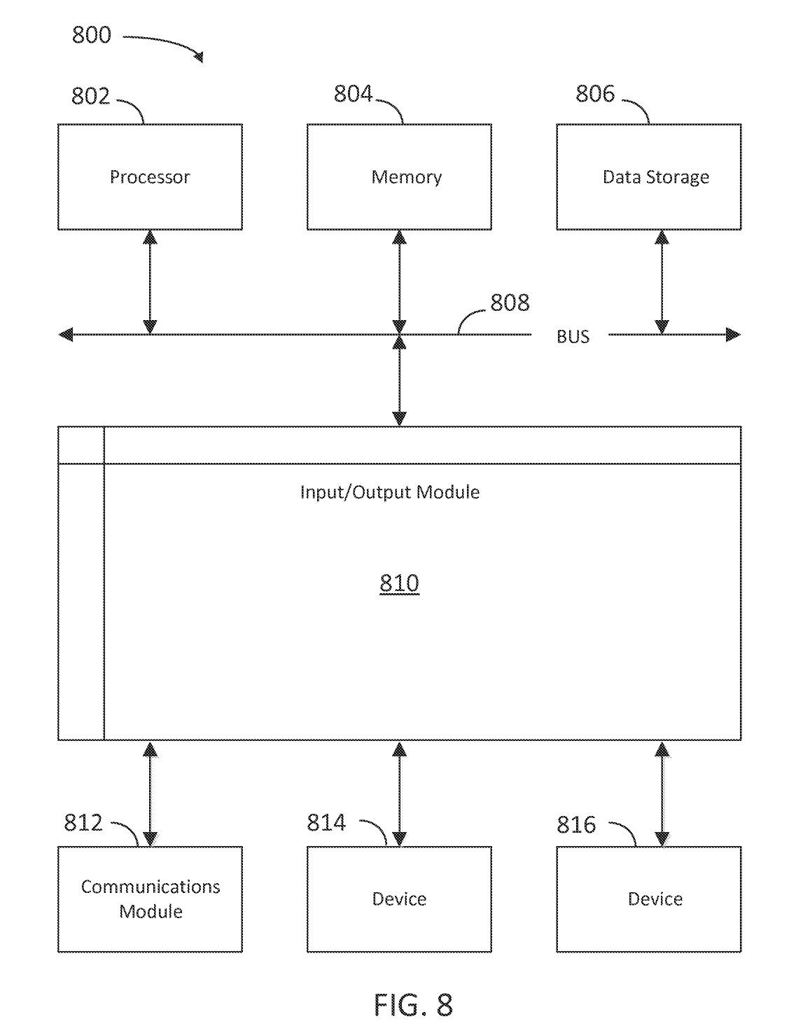

FIG. 8 is a block diagram illustrating an example computer system 800 with which the personal computing device of FIGS. 1-2 can be implemented. In certain aspects, computer system 800 can be implemented using hardware or a combination of software and hardware, either in a dedicated server, integrated into another entity, or distributed across multiple entities.

Computer system 800 (e.g., personal computing devices 120 and servers 110) includes a bus 808 or other communication mechanism for communicating information, and a processor 802 (e.g., processor circuit 212) coupled with bus 808 for processing information. By way of example, computer system 800 can be implemented with one or more processors 802. Processor 802 can be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 includes, in addition to hardware, code that creates an execution environment for the computer program in question, e.g., code that constitutes processor firmware, a protocol stack, a database management system, an operating system, or a combination of one or more of them stored in an included memory 804 (e.g., memory circuit 220), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. Processor 802 and memory 804 can be supplemented by, or incorporated in, special purpose logic circuitry.

The instructions may be stored in memory 804 and implemented in one or more computer program products, i.e., one or more modules of computer program instructions encoded on a computer readable medium for execution by, or to control the operation of, the computer system 800, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, embeddable languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 is coupled via input/output module 810 to various devices. The input/output module 810 is any input/output module. Example input/output modules 810 include data ports such as USB ports. The input/output module 810 is configured to connect to a communications module 812. Example communications modules 812 (e.g., communications module 218) include networking interface cards, such as Ethernet cards and modems. In certain aspects, the input/output module 810 is configured to connect to a plurality of devices, such as an input device 814 (e.g., input device 214) and/or an output device 816 (e.g., display 206). Example input devices 814 include a keyboard and a pointing device, e.g., a mouse or a trackball, by which a user can provide input to the computer system 800. Other kinds of input devices 814 are used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 816 include display devices, such as a LED (light emitting diode), CRT (cathode ray tube), or LCD (liquid crystal display) screen, for displaying information to the user.

According to one aspect of the present disclosure, personal computing device 120 can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 800 includes servers and personal computer devices, such as servers 110 and personal computing devices 120, described in detail above. A personal computing device and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 802 for execution. Such a medium may take many forms, including, but not limited to, non-volatile media, volatile media, and transmission media. Non-volatile media include, for example, optical disks, magnetic disks, or flash memory, such as data storage device 806. Volatile media include dynamic memory, such as memory 804. Transmission media include coaxial cables, copper wire, and fiber optics, including the wires that comprise bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of ” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C. To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for providing a user interface for displaying and queueing notifications in a multi-purpose application environment, the method comprising:
displaying an application launching interface comprising a plurality of applications in response to a user gesture, wherein the application launching interface is hidden from display prior to the user gesture;
displaying a notification associated with one of the plurality of applications to the user; and
queueing an action when the user provides a queueing gesture for the notification, wherein the queued action is displayed for later performance when selected by the user.

2. The computer-implemented method of claim 1, further comprising removing the notification from display according to a user gesture or after a selected period of time.

3. The computer-implemented method of claim 1, wherein the application launching interface comprises an overflow panel displayed in response to the notification to the user, or in response to a request from the user.

4. The computer-implemented method of claim 1, wherein:
the plurality of applications comprises a web browsing application; and
the queueing gesture comprises a gesture indicating a request to store a Uniform Resource Locator (URL) item in a web browser bucket.

5. The computer-implemented method of claim 1, wherein:
the plurality of applications comprises a social networking application; and
the displaying the notification comprises displaying a chat request from a person associated with the user in the social networking application.

6. The computer-implemented method of claim 1, wherein:
the plurality of applications comprises a media playing application;
the displaying the notification comprises displaying a media player control; and
the launching gesture comprises selecting one of a play button, a pause button, a skip button, a mute button, or an unmute button.

7. The computer-implemented method of claim 1, further comprising performing an action in response to the notification when the user provides a launching gesture, the launching gesture comprising at least one tap on an icon representing the application.

8. The computer-implemented method of claim 1, wherein the queueing gesture comprises a swiping gesture.

9. The computer-implemented method of claim 1, wherein providing the application launching interface comprises spatially separating different applications from the plurality of applications according to a plurality of buckets, each bucket associated with an application category.

10. The computer-implemented method of claim 9, wherein the plurality of buckets comprise a social networking bucket, a web browsing bucket, a media player bucket, and a catch-all bucket.

11. A personal computing device for providing a user interface for displaying and queueing notifications in a multi-purpose application environment, the personal computing device comprising:
a memory comprising instructions;
a processor configured to execute the instructions; and
a display configured to receive a user input, wherein the processor is configured, upon executing the instructions, to cause the personal computing device to:
display an application launching interface comprising a plurality of application upon receiving a user gesture, wherein the application launching interface is hidden from display prior to the user gesture;
display a notification to a user associated with one of the plurality of applications to the user;
queue an action when the user provides a queueing gesture for the notification, wherein the queued action is displayed for later performance when selected by the user; and
remove the overflow panel from display according to a user priority.

12. The device of claim 11 wherein the personal computing device comprises at least one of a laptop, a tablet, a convertible device, or a smart phone.

13. The device of claim 11, wherein the instructions comprise a plurality of applications configured to communicate with at least one remote server, and the instructions also comprise an Application Programming Interface (API) in an operating system of the personal computing device configured to communicate with the at least one remote server.

14. The device of claim 11, wherein to provide an application launching interface comprises to separate different applications into a plurality of buckets, each bucket associated with a category selected from one of a web browsing category, a social networking category, a media player category, and a catch-all category.

15. The device of claim 11, wherein the processor further causes the personal computing device to perform an action in response to the notification when the user provides a launching gesture, the launching gesture comprising a double tap on an icon in the overflow panel, the icon associated with the one of the plurality of applications.

16. The device of claim 11, wherein the queuing gesture comprises a swiping gesture directing an object in the display to an icon in the overflow panel, the icon associated with the one of the plurality of applications.

17. A non-transitory, computer readable medium comprising machine-readable instructions for causing a processor to execute a method for providing a user interface for displaying and queueing notifications in a multi-purpose application environment, the method comprising:
displaying an application launching interface comprising a plurality of applications upon a user gesture, wherein the application launching interface is hidden from display prior to the user gesture;
displaying a notification associated with one of the plurality of applications to the user; and
queueing an action when the user provides a queueing gesture for the notification, wherein the queued action is displayed for later performance when selected by the user; wherein:
displaying an application launching interface comprises spatially separating the plurality of applications according to a plurality of categories comprising at least one of a web browsing category, a social networking category, and a media playing category.

18. The non-transitory, computer-readable medium of claim 17, wherein spatially separating the plurality of applications according to a plurality of categories comprises stacking icons associated with the plurality of applications in a bucket associated with a category selected from the plurality of categories.

19. The non-transitory, computer-readable medium of claim 17, wherein the method further comprises performing an action in response to the notification when the user provides a launching gesture, the launching gesture comprising tapping at least twice on an icon in the application launching interface, the icon associated with the one of the plurality of applications.

20. The non-transitory, computer-readable medium of claim 17, wherein the queueing gesture comprises swiping a finger directing an object in the display to an icon in the application launching interface.
